(19) United States
(12) Patent Application Publication
(10) Pub. No.: US 2018/0278497 A1
(43) Pub. Date: Sep. 27, 2018

(54) SYSTEMS FOR MONITORING APPLICATION SERVERS

(71) Applicant: Quanta Computer Inc., Taoyuan City (TW)

(72) Inventors: Chien-Kuo HUNG, Taoyuan City (TW); Tsai-Hsing LU, Taoyuan City (TW); Chun-Hung CHEN, Taoyuan City (TW); Wen-Kuang CHEN, Taoyuan City (TW); Chen-Chung LEE, Taoyuan City (TW)

(21) Appl. No.: 15/626,356

(22) Filed: Jun. 19, 2017

(30) Foreign Application Priority Data
Mar. 22, 2017 (TW) 106109495

(51) Int. Cl. H04L 12/26

(52) U.S. Cl. CPC H04L 43/04; H04L 43/12; H04L 43/14; H04L 43/0876

(57) ABSTRACT

A monitoring system is provided to perform a monitoring operation including: initiating a first process to serve as a first task agent for determining whether there is a monitoring item among the application servers, and if so, generating a monitoring task; initiating a second process to serve as a second task agent for obtaining monitoring data by monitoring the monitoring item according to the monitoring task; initiating a third process to serve as a third task agent for determining whether the monitoring data meets an abnormality definition associated with the monitoring task, and if so, generating an alert message; and initiating a fourth process to serve as a fourth task agent for determining, according to an alert rule, whether or not to send the alert message to a manager of the application server with which the monitoring item is associated.

### CROSS REFERENCE TO RELATED APPLICATIONS

This Application claims priority of Taiwan Application No. 106109495, filed on Mar. 22, 2017, and the entirety of which is incorporated by reference herein.

### BACKGROUND OF THE APPLICATION

### Field of the Application

The application relates generally to service or equipment monitoring technologies, and more particularly, to monitoring systems in which multiple processes are used to share out the work of monitoring application servers.

### Description of the Related Art

Due to growing demand for ubiquitous computing and networking, various wireless technologies, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, and Time-Division LTE (TD-LTE) technology, etc, have been developed to contribute to ubiquitous network access.

With the convenience of ubiquitous network access, it has become a common choice for service providers to set up their application servers on the Internet to allow users to access the applications or services run on the application servers. In such cases, how to maintain stability of the application servers is an important issue, and a conventional solution is to monitor the application servers and immediately notify the manager to deal with the malfunctioning or abnormal applications or services in the early stages of any developing problems. However, as the amount of monitoring tasks grows rapidly, the monitoring system may not be able to handle all the monitoring tasks in a timely fashion, causing undesirable delays in spotting and handling the malfunctioning or abnormal applications or services.

For an exemplary implementation of such a conventional monitoring system, it is a common practice to assign a respective process to be in charge of monitoring one item, such as an application or service. Nonetheless, the monitoring operation may be broken down into several stages, and the stages are tightly interrelated with one another, such that a stage of the monitoring operation may be performed only if the previous stage has been completed. Disadvantageously, when the loading of the monitoring operation weighs mostly on one of the stages, this stage may very likely become a performance bottleneck in the entire monitoring operation, and the rest of the stages will be idle until this stage is complete. If the number of processes performing the monitoring operation is increased to alleviate the performance bottleneck, the idle stages therein will be increased as well, causing waste of system resources. On the other hand, if any one of the stages needs a retry due to some temporary problem, the entire monitoring operation will be performed again from the first stage. Therefore, the conventional design is unfavorable regarding overall system performance and system resource utilization.

### BRIEF SUMMARY OF THE APPLICATION

In order to solve the aforementioned problem, the present application proposes to break down a monitoring task into multiple stages and assign a respective process for performing one of the stages. When the loading of any stage becomes too high, the number of processes in charge of performing the stage is increased. When the loading of any stage becomes too low, the number of processes in charge of performing the stage is decreased. Therefore, the present application efficiently improves system performance and system resource utilization.

In one aspect of the application, a monitoring system comprising a communication device, a storage device, and a controller is provided. The communication device is configured to provide a network connection to the Internet and one or more application servers on the Internet. The storage device is configured to store computer-executable instructions or program code. The controller is configured to load and execute the computer-executable instructions or program code to monitor the application servers, wherein the monitoring of the application servers comprises: initiating a first process to serve as a first task agent for determining whether there is a monitoring item among the application servers and generating a monitoring task when there is a monitoring item among the application servers; initiating a second process to serve as a second task agent for obtaining monitoring data by monitoring the monitoring item according to the monitoring task; initiating a third process to serve as a third task agent for determining whether the monitoring data meets an abnormality definition associated with the monitoring task and generating an alert message when the monitoring data meets the abnormality definition; and initiating a fourth process to serve as a fourth task agent for determining, according to an alert rule, whether or not to send the alert message to a manager of the application server with which the monitoring item is associated.

Other aspects and features of the application will become apparent to those with ordinary skill in the art upon review of the following descriptions of specific embodiments of the monitoring systems.

### BRIEF DESCRIPTION OF THE DRAWINGS

The application can be more fully understood by reading the subsequent detailed description and examples with references made to the accompanying drawings, wherein:

FIG. 1 is a schematic diagram illustrating a monitoring environment according to an embodiment of the application;

FIG. 2 is a block diagram illustrating the hardware architecture of the monitoring system 10 according to an embodiment of the application;

FIG. 3 is a block diagram illustrating the software architecture of the method for monitoring application servers according to an embodiment of the application;

FIG. 4 is a flow chart illustrating the operation of the monitoring initiation agent 321 according to an embodiment of the application;

FIG. 5 is a flow chart illustrating the operation of the data collection agent 322 according to an embodiment of the application;

FIG. 6 is a flow chart illustrating the operation of the abnormality determination agent 323 according to an embodiment of the application;

FIGS. 7A and 7B show a flow chart illustrating the operation of the alert agent 324 according to an embodiment of the application; and

FIG. 8 is a block diagram illustrating the monitoring operation of the application servers according to the embodiment of FIG. 3.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof.

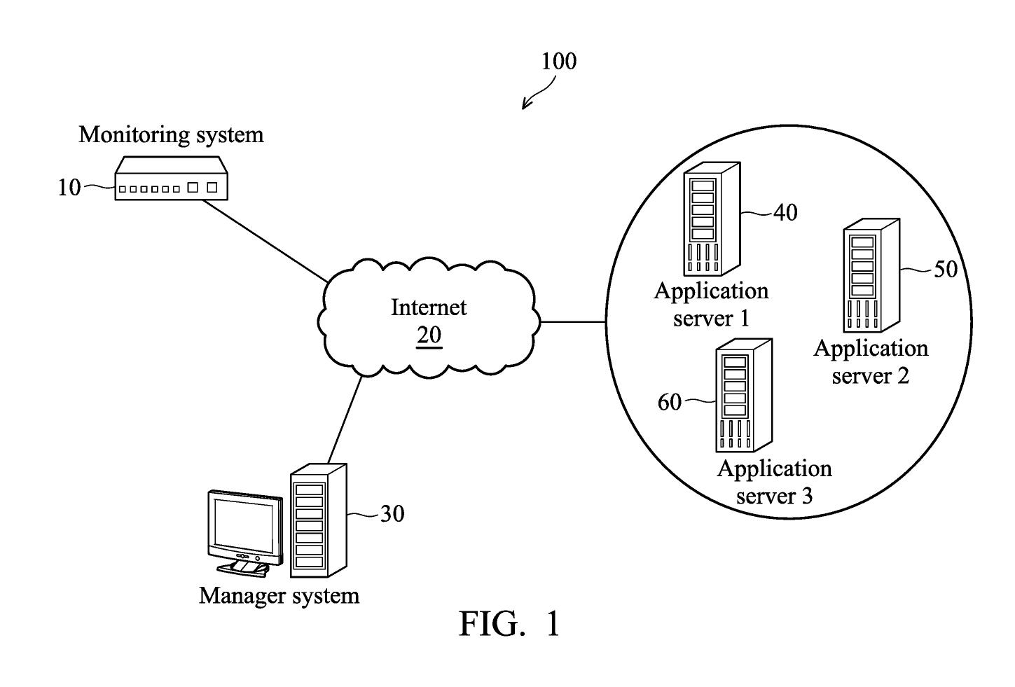

FIG. 1 is a schematic diagram illustrating a monitoring environment according to an embodiment of the application. The monitoring environment 100 includes a monitoring system 10, the Internet 20, a manager system 30, and application servers 40˜60, wherein the monitoring system 10 and the manager system 30 may connect to the application servers 40˜60 through the Internet 20.

The monitoring system 10 may be a computer host or a computing device with a wired/wireless communication function, such as a notebook PC, a desktop computer, a workstation, or a server, etc., which is configured to monitor the application servers 40˜60 and send alert messages to the manager system 30 when detecting abnormalities of the application servers 40˜60.

Each of the application servers 40˜60 may be a server configured to provide one or more applications or services, such as E-mail service, mobile push service, web page service, hardware equipment service, equipment monitoring service, or short message service.

The manager system 30 may be a computing device with a wired/wireless communication function, such as a notebook PC, a desktop computer, a workstation, or a server, etc., which is configured to manage the application servers 40˜60, including configuring, checking, debugging, and/or maintaining the application servers 40˜60.

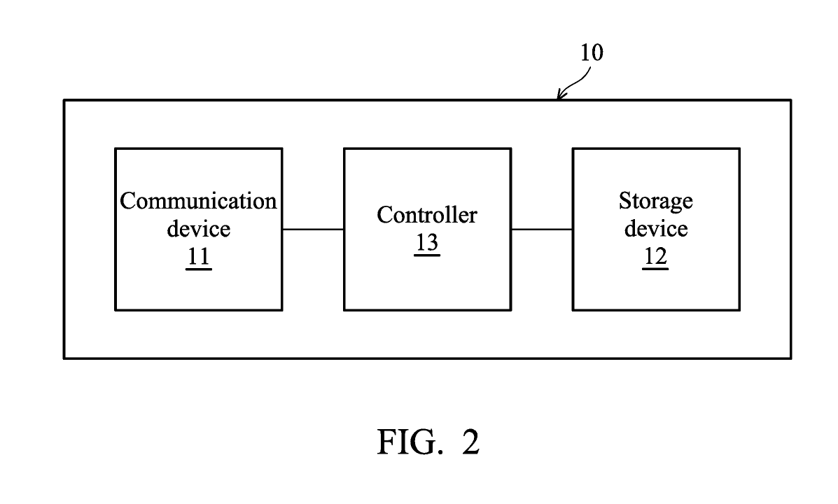

FIG. 2 is a block diagram illustrating the hardware architecture of the monitoring system 10 according to an embodiment of the application. The monitoring system 10 includes a communication device 11, a storage device 12, and a controller 13.

The communication device 11 is responsible for providing a network connection to the Internet 20, the manager system 30 and the application servers 40˜60 on the Internet 20. The communication device 11 may provide the network connection using a wired/wireless communication technology, such as the Ethernet, Wireless Fidelity (Wi-Fi), Worldwide Interoperability for Microwave Access (WiMAX), Global System for Mobile communications (GSM), Wideband Code Division Multiple Access (WCDMA), or Long Term Evolution (LTE) technology.

The storage device 12 is a non-transitory machine-readable storage medium, such as a Random Access Memory (RAM), or a FLASH memory, or a magnetic storage device, such as a hard disk or a magnetic tape, or an optical disc, or any combination thereof for storing computer-executable instructions or program code, including instructions or program code of applications/services and/or communication protocols. In addition, the storage device 12 stores computer-executable instructions or program code of the method of the present application. In one embodiment, the storage device 12 further stores a database that is used in the method of the present application.

The controller 13 may be a general-purpose processor, a Micro Control Unit (MCU), an Application Processor (AP), or a Digital Signal Processor (DSP), which includes various circuits for performing the functions of data processing and computing, controlling the communication device 11 to provide the network connection, and reading or storing data from or to the storage device 12. In particular, the controller 13 coordinates the operations of the communication device 11 and the storage device 12 to carry out the method of the present application.

As will be appreciated by persons skilled in the art, the circuits in the controller 13 will typically include transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in design of electronic and digital systems.

It should be understood that the components described in the embodiment of FIG. 2 are for illustrative purposes only and are not intended to limit the scope of the application. For example, the monitoring system 10 may further include a display device (e.g., a Liquid-Crystal Display (LCD), Light-Emitting Diode (LED) display, or Electronic Paper Display (EPD), etc.), an Input/Output (I/O) device (e.g., one or more buttons, a keyboard, a mouse, a touch pad, a video camera, or a microphone, etc.), a power supply, and/or a Global Positioning System (GPS) device.

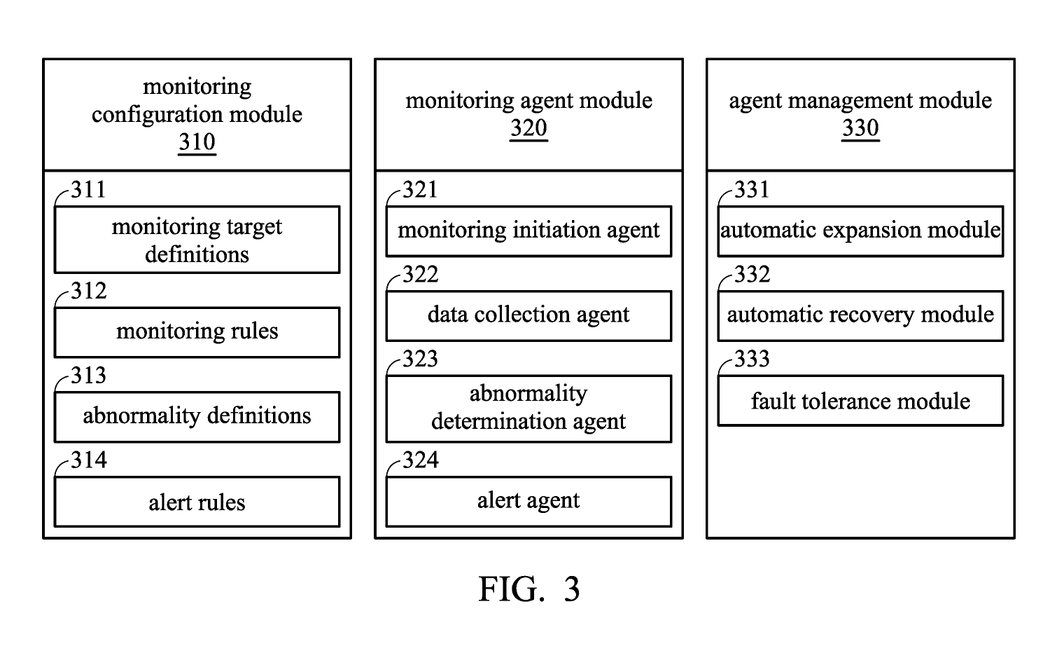

FIG. 3 is a block diagram illustrating the software architecture of the method for monitoring application servers according to an embodiment of the application. In this embodiment, the method for monitoring application servers is applied to the monitoring system 10. Specifically, the method for monitoring application servers may be implemented with multiple software modules which is further loaded and executed by the controller 13. The software architecture includes a monitoring configuration module 310, a monitoring agent module 320, and an agent management module 330.

The monitoring configuration module 310 is responsible for providing the monitoring configurations required for the monitoring operations, wherein the monitoring configurations include various definitions, conditions, and rules which may be stored in a database and updated according to the variations of the application servers 40˜60. Specifically, the monitoring configuration module 310 includes monitoring target definitions 311, monitoring rules 312, abnormality definitions 313, and alert rules 314.

The monitoring target definitions 311 specify the monitoring targets, such as which application or service run on which application server.

The monitoring rules 312 specify the rules for carrying out the monitoring operations. In one embodiment, multiple periods of time for performing a monitoring operation may be configured, and different monitoring rules may be configured for different periods of time. For example, a period of time (i.e., the activation period) may be configured as “8:00 am to 5:00 pm on every Monday to Friday”, and in this period of time, the monitoring operation may be configured to be performed every 30 seconds, 1 minute, or 10 minutes, and retried a predetermined number of times with a time interval between two successive retries. In one embodiment, the retry of the monitoring operation may exclude false detection of abnormality, such as the temporary abnormality caused by a burst of system loading.

The abnormality definitions 313 specify the abnormality definitions of each monitoring target. For example, an abnormality definition may refer to the CPU loading of an application server exceeding 80 percent of its maximum capability for more than 10 minutes, wherein the CPU loading may be one of the preconfigured monitoring types. It should be noted that the abnormality definitions may be modified or new abnormality definitions may be added at any time.

The alert rules 314 specify the rules for determining whether or not to send alert messages when an abnormality of the monitoring target occurs. For example, an alert rule may be configured as “sending alert messages upon each occurrence of an abnormality”, “sending an alert message only once for the occurrences of the same abnormality”, “sending an alert message only once in a predetermined period of time for the occurrences of the same abnormality”, or “sending an alert message for a predetermined number of occurrences of the same abnormality”.

The monitoring agent module 320 includes a monitoring initiation agent 321, a data collection agent 322, an abnormality determination agent 323, and an alert agent 324, wherein each agent is performed by one or more processes and is responsible for handling a respective stage of the monitoring operation, so that the monitoring operation may be completed with the collective work of the agents. In one embodiment, the agents may each be realized by a process initiated by a respective host.

The monitoring initiation agent 321 is responsible for initiating a process to serve as a task agent for determining whether there is a monitoring item among the application servers and generating a monitoring task when there is a monitoring item among the application servers.

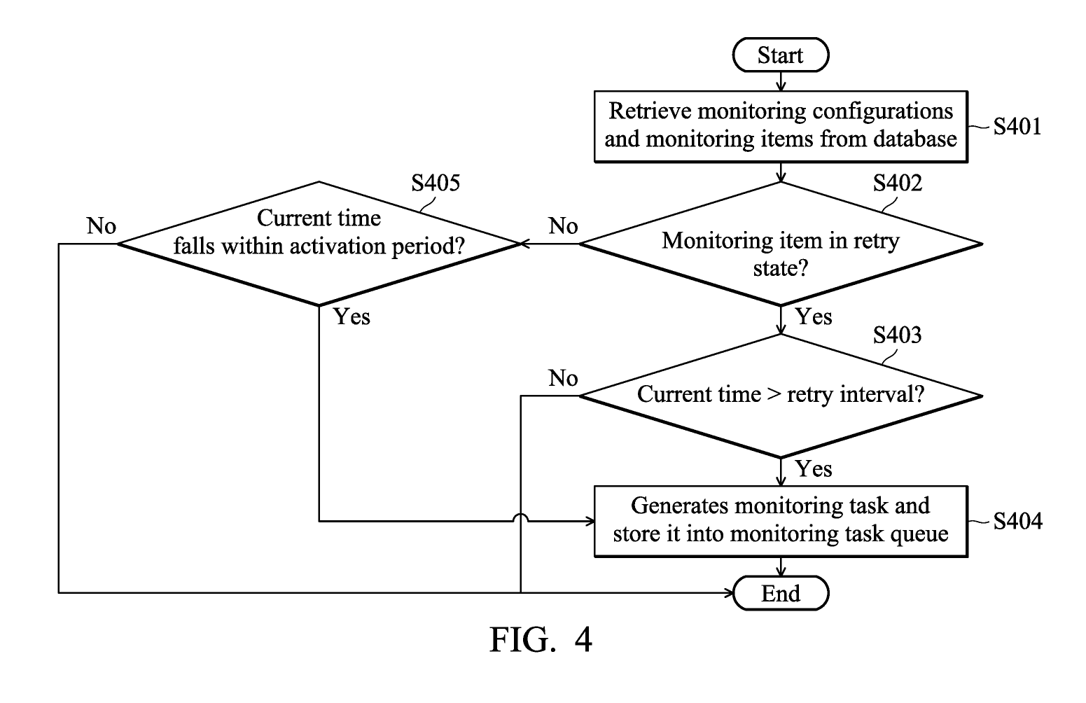

FIG. 4 is a flow chart illustrating the operation of the monitoring initiation agent 321 according to an embodiment of the application. To begin, the monitoring initiation agent 321 periodically checks the database for the monitoring configurations of the application servers 40˜60 and the configured monitoring items, so as to determine that one of the configured monitoring items matches the monitoring configurations (i.e., there is a monitoring item among the application servers) (step S401). Next, the monitoring initiation agent 321 determines whether the monitoring item is in the retry state (step S402). When the monitoring item is in the retry state, the monitoring initiation agent 321 determines whether the current time exceeds the predetermined retry interval (i.e., whether the current time reaches the predetermined retry time) (step S403), and if so, generates a monitoring task to retry monitoring the monitoring item and stores the monitoring task into the monitoring task queue (step S404), and the method ends. It should be noted that step S402 may be optional and it is meant to check if an abnormality has occurred in a previous monitoring operation of the monitoring item.

The monitoring task queue is a First-In-First-Out (FIFO) queue. That is, the monitoring tasks that are stored earlier into the monitoring task queue will be retrieved earlier by the data collection agent 322.

The monitoring task includes the information required for performing the monitoring operation of the monitoring item, including the monitoring target, the monitoring type, the monitoring rules, the abnormality definitions, and the alert rules.

Subsequent to step S402, if the monitoring item is not in the retry state, the monitoring initiation agent 321 determines whether the current time falls within an activation period specified in the monitoring configurations (step S405), and if so, the method proceeds to step S404. Otherwise, if the current time does not fall within the activation period, the method ends.

The data collection agent 322 is responsible for initiating one or more processes to serve as one or more task agents for obtaining monitoring data by monitoring the monitoring item according to the monitoring task, wherein each task agent is performed by a respective process.

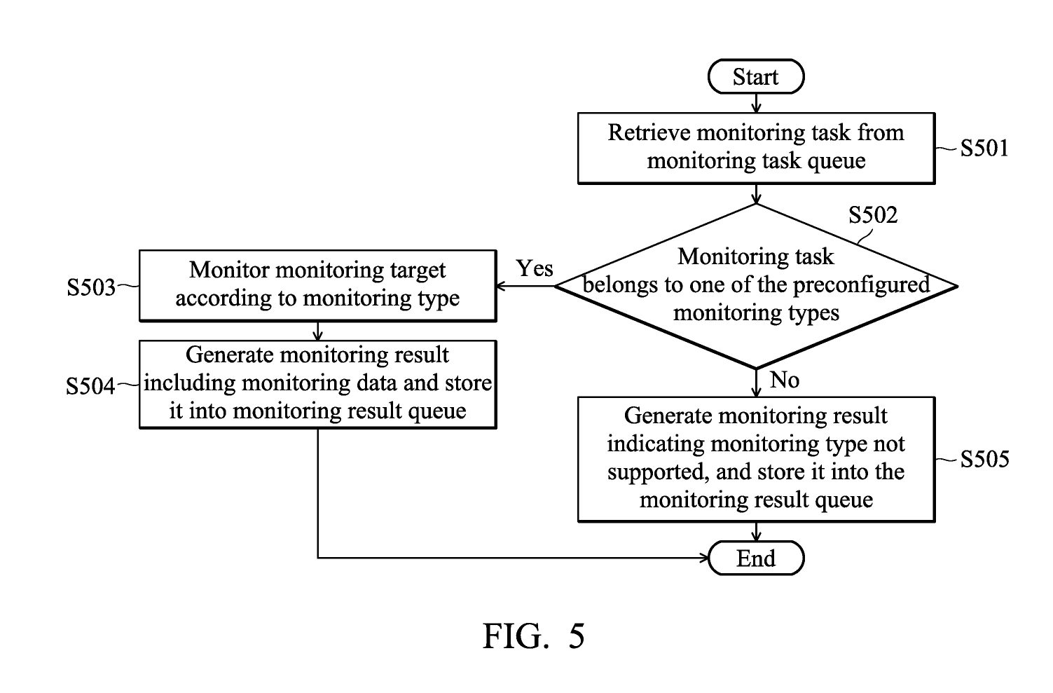

FIG. 5 is a flow chart illustrating the operation of the data collection agent 322 according to an embodiment of the application. To begin, the data collection agent 322 retrieves a monitoring task from the monitoring task queue (step S501), and determines whether the type of the monitoring task belongs to one of the preconfigured monitoring types (step S502). When the type of the monitoring task belongs to one of the preconfigured monitoring types, the data collection agent 322 monitors the monitoring target specified by the monitoring task according to the monitoring type and obtains monitoring data (step S503). Next, the data collection agent 322 includes the monitoring data in a monitoring result and stores the monitoring result into the monitoring result queue (step S504), and the method ends.

For example, there may be multiple monitoring types, such as monitoring types 1˜4, wherein the monitoring type 1 indicates the data collection agent 322 to obtain the data concerning the CPU loading of the monitoring target, the monitoring type 2 indicates the data collection agent 322 to obtain the data concerning the memory usage of the monitoring target, the monitoring type 3 indicates the data collection agent 322 to obtain the data concerning the hard-drive usage of the monitoring target, and the monitoring type 4 indicates the data collection agent 322 to obtain the data concerning the network traffic of the monitoring target.

Subsequent to step S502, if the type of the monitoring task does not belong to any one of the preconfigured monitoring types, the data collection agent 322 generates a monitoring result indicating that the type of the monitoring task is not supported, and stores the monitoring result into the monitoring result queue (step S505), and the method ends.

The monitoring result queue is a FIFO queue. That is, the monitoring results that are stored earlier into the monitoring result queue will be retrieved earlier by the abnormality determination agent 323.

The abnormality determination agent 323 is responsible for initiating one or more processes to serve as one or more task agents for determining whether the monitoring data in the monitoring result is abnormal and generating an alert message for the abnormal monitoring data, wherein each task agent is performed by a respective process.

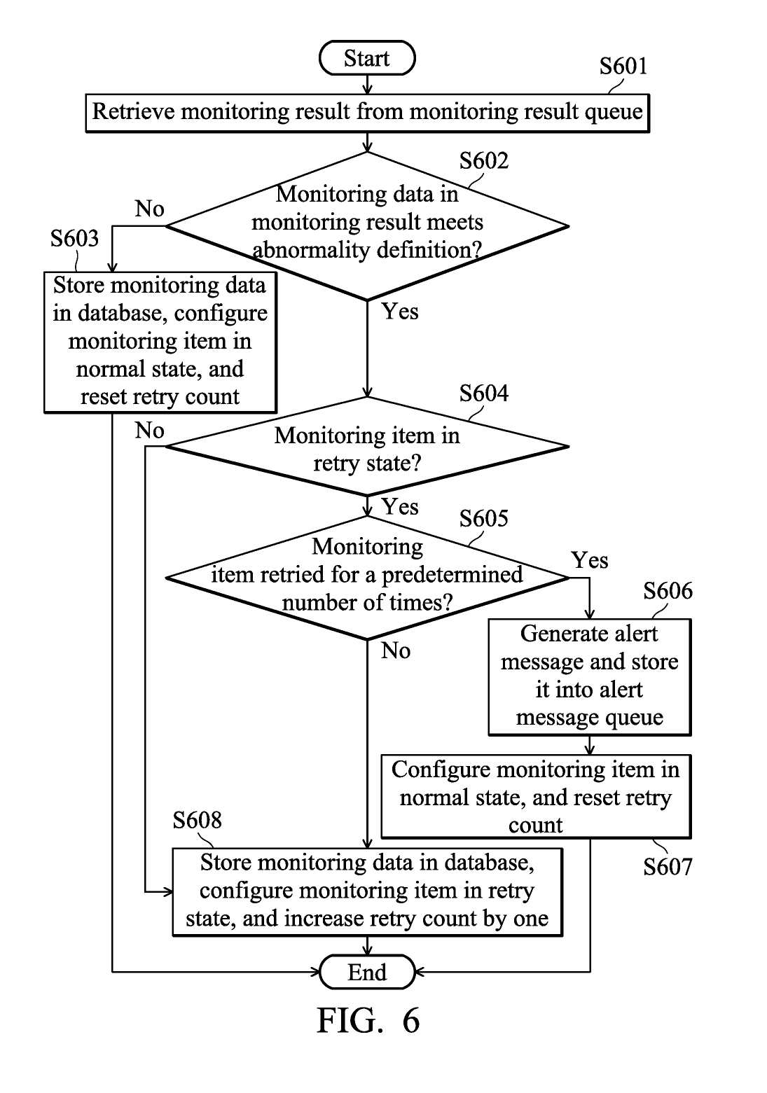

FIG. 6 is a flow chart illustrating the operation of the abnormality determination agent 323 according to an embodiment of the application. To begin, the abnormality determination agent 323 retrieves a monitoring result from the monitoring result queue (step S601), and determines whether the monitoring data in the monitoring result meets an abnormality definition (step S602). When the monitoring data does not meet any abnormality definition, the abnormality determination agent 323 stores the monitoring data in the database, configures the monitoring item to be in a normal state, and resets the retry count of the monitoring item (step S603), and the method ends.

The abnormality definition is associated with a current monitoring task. For example, if a current monitoring task is to monitor the traffic throughput of an email server, the abnormality definition may refer to the situation where the traffic throughput of the email server exceeds a threshold.

Subsequent to step S602, if the monitoring data meets an abnormality definition, the abnormality determination agent 323 determines whether the corresponding monitoring item is in the retry state (step S604), and if so, determines whether the monitoring item has been retried a predetermined number of times (step S605). If the monitoring item has been retried the predetermined number of times, the abnormality determination agent 323 generates an alert message and stores the alert message into the alert message queue (step S606). Next, the abnormality determination agent 323 configures the monitoring item to be in the normal state, and resets the retry count of the monitoring item (step S607), and the method ends.

To further clarify, steps S604 and S605 may improve the correct rate of the determination of whether the monitoring data meets the abnormality definition, by excluding the situation where a single occurrence of an abnormality of the monitoring data may be determined even if the situation itself is not alertable. That is, the abnormality may be a false one, and steps S604 and S605 allows the abnormality determination agent 323 to make sure that the abnormality is true and alertable (i.e., performs steps S606 and S607) by retrying the monitoring item with abnormal monitoring data a few more times. In one embodiment, the number of retries may be predetermined to be 3 or 4.

The alert message queue is a FIFO queue. That is, the alert messages that are stored earlier into the alert message queue will be retrieved earlier by the alert agent 324.

Subsequent to step S605, if the monitoring item has not been retried the predetermined number of times, the abnormality determination agent 323 stores the monitoring data in the database, configures the monitoring item to be in the retry state, and increases the retry count of the monitoring item by one (step S608), and the method ends.

The alert agent 324 is responsible for initiating one or more processes to serve as one or more task agents for determining whether or not to send the alert message to the manager of the application server with which the monitoring item is associated, wherein each task agent is performed by a respective process.

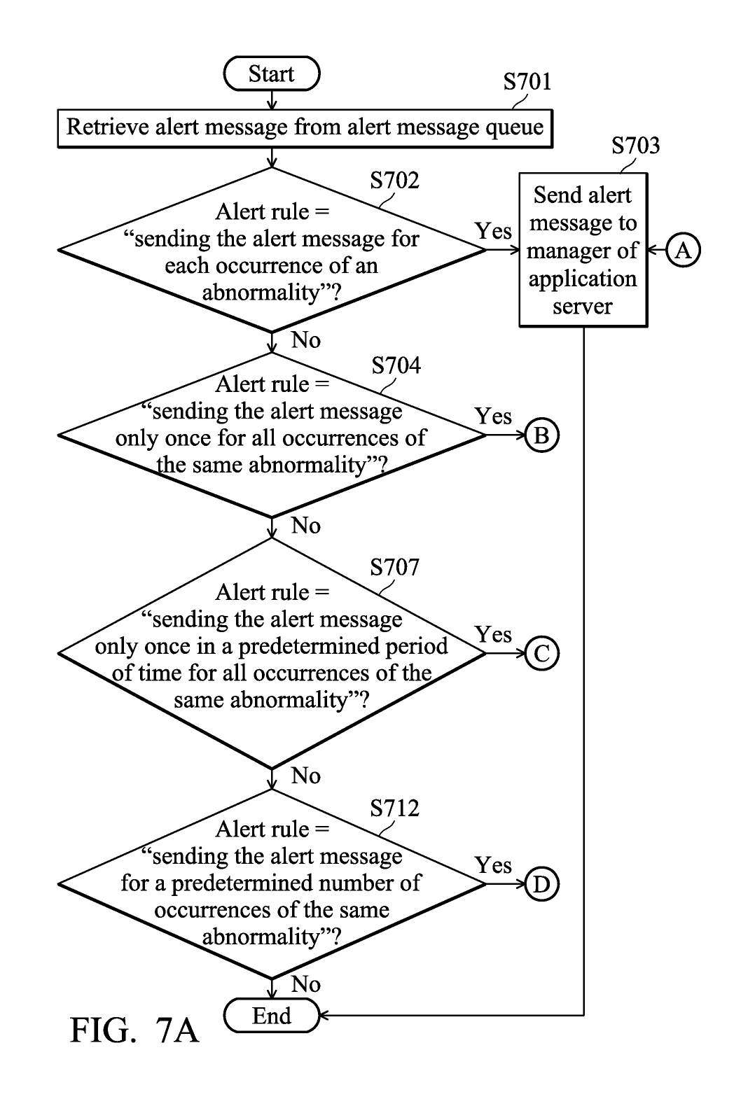

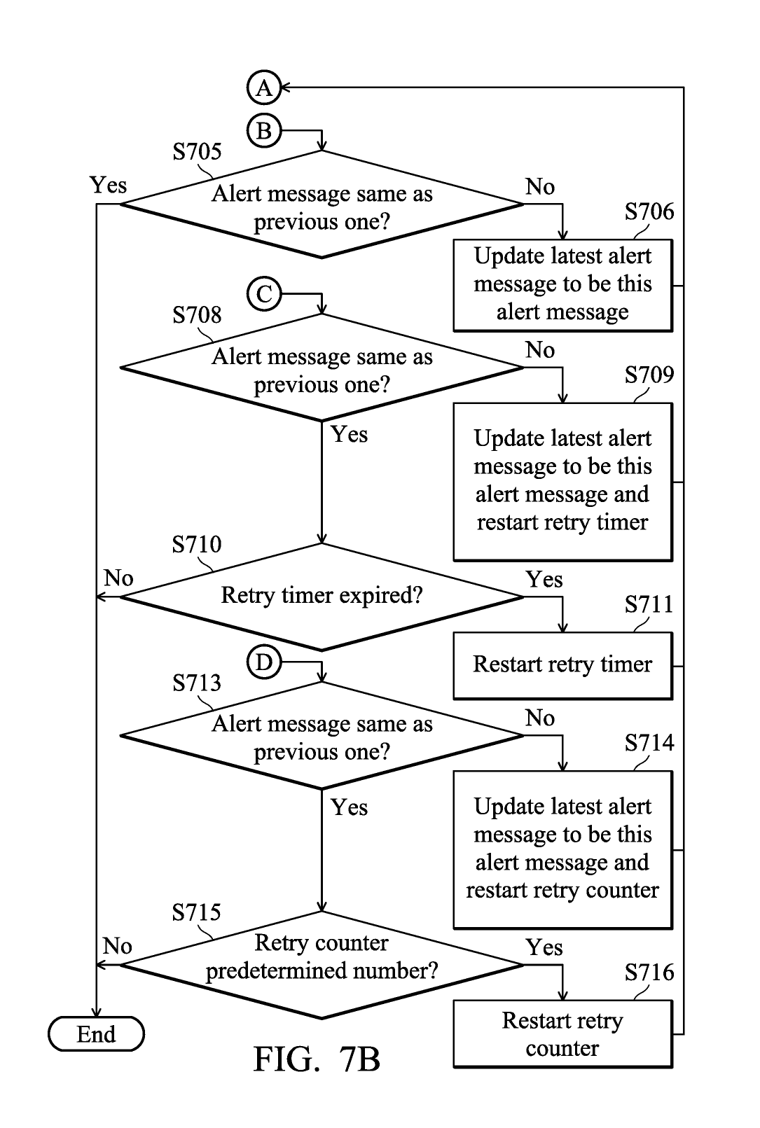

FIGS. 7A and 7B show a flow chart illustrating the operation of the alert agent 324 according to an embodiment of the application. To begin, the alert agent 324 retrieves an alert message from the alert message queue (step S701), and determines whether or not to send the alert message to the manager of the application server according to the alert rule.

Specifically, the alert agent 324 determines whether the alert rule indicates “sending the alert message for each occurrence of an abnormality” (step S702), and if so, sends the alert message to the manager of the application server with which the current monitoring item is associated (step S703), and the method ends. Otherwise, if the alert rule does not indicate “sending the alert message for each occurrence of an abnormality”, the alert agent 324 determines whether the alert rule indicates “sending the alert message only once for all occurrences of the same abnormality” (step S704), and if so, determines whether this alert message is the same as the previous alert message of the current monitoring item (step S705).

Subsequent to step S705, if this alert message is the same as the previous one, the alert agent 324 does not send this alert message and the method ends. Otherwise, if this alert message is not the same as the previous one, the alert agent 324 updates the latest alert message of the current monitoring item to be this alert message (step S706), and the method proceeds to step S703.

Subsequent to step S704, if the alert rule does not indicate “sending the alert message only once for all occurrences of the same abnormality”, the alert agent 324 determines whether the alert rule indicates “sending the alert message only once in a predetermined period of time for all occurrences of the same abnormality” (step S707), and if so, determines whether this alert message is the same as the previous alert message of the current monitoring item (step S708).

Subsequent to step S708, if this alert message is not the same as the previous one, the alert agent 324 updates the latest alert message of the current monitoring item to be this alert message and restarts the retry timer (step S709), and the method proceeds to step S703. Otherwise, if this alert message is the same as the previous one, the alert agent 324 determines whether the retry timer corresponding to the current monitoring item has expired (the expiry of the retry timer indicates that the predetermined period of time has passed since the last and the same alert message) (step S710), and if so, restarts the retry timer (step S711), and the method proceeds to step S703. Otherwise, if the retry timer has not expired yet, the method ends.

Subsequent to step S707, if the alert rule does not indicate “sending the alert message only once in a predetermined period of time for all occurrences of the same abnormality”, the alert agent 324 determines whether the alert rule indicates “sending the alert message for a predetermined number of occurrences of the same abnormality” (step S712), and if not, the method ends. Otherwise, if the alert rule indicates “sending the alert message for a predetermined number of occurrences of the same abnormality”, determines whether this alert message is the same as the previous alert message of the current monitoring item (step S713).

Subsequent to step S713, if this alert message is not the same as the previous one, the alert agent 324 updates the latest alert message of the current monitoring item to be this alert message and restarts the retry counter (step S714), and the method proceeds to step S703. Otherwise, if this alert message is the same as the previous one, the alert agent 324 determines whether the value of the retry counter is greater than or equal to a predetermined number (i.e., the same alert messages have accumulated to a predetermined number) (step S715), and if so, restarts the retry counter (step S716), and the method proceeds to step S703. Otherwise, if the retry counter is not greater than or equal to a predetermined number, the method ends.

Referring back to FIG. 3, the agent management module 330 includes an automatic expansion module 331, an automatic recovery module 332, and a fault tolerance module 333.

The automatic expansion module 331 is responsible for checking the length of the monitoring task queue, the monitoring result queue, and the alert message queue, and when any one of the queue length exceeds a predetermined multiple of the number of corresponding task agents (e.g., the data collection agents, the abnormality determination agents, or the alert agents), initiating a new process to add one more task agent (i.e., a duplicate of the corresponding task agent), so as to speed up the processing of the messages in the queue. For example, when the length of the monitoring task queue is greater than 10 times of the number of the data collection agents, a new process is initiated to add one more data collection agent.

The automatic recovery module 332 is responsible for checking the length of the monitoring task queue, the monitoring result queue, and the alert message queue, and when any one of the queue length is less than a predetermined multiple of the number of corresponding task agents (e.g., the data collection agents, the abnormality determination agents, or the alert agents), removing one of corresponding task agents, so as to save system resources. For example, when the length of the monitoring result queue is less than 5 times of the number of the abnormality determination agents, one of the abnormality determination agents is removed and the associated process is freed.

The fault tolerance module 333 is responsible for providing a fault tolerance mechanism for the operations of the task agents. Specifically, when an error of the operation of a task agent occurs, the fault tolerance module 333 records the error and determines whether the task agent has been retried a predetermined number of times (upper limit for tolerance), and if not, undoes the operation of the task agent, updates the retry count of the associated message (i.e., a monitoring task, a monitoring result, or an alert message), and stores the message back into the corresponding queue (i.e., the monitoring task queue, the monitoring result queue, or the alert message queue) for the next retry. Otherwise, if the task agent has been retried the predetermined number of times, the operation of the task agent is terminated.

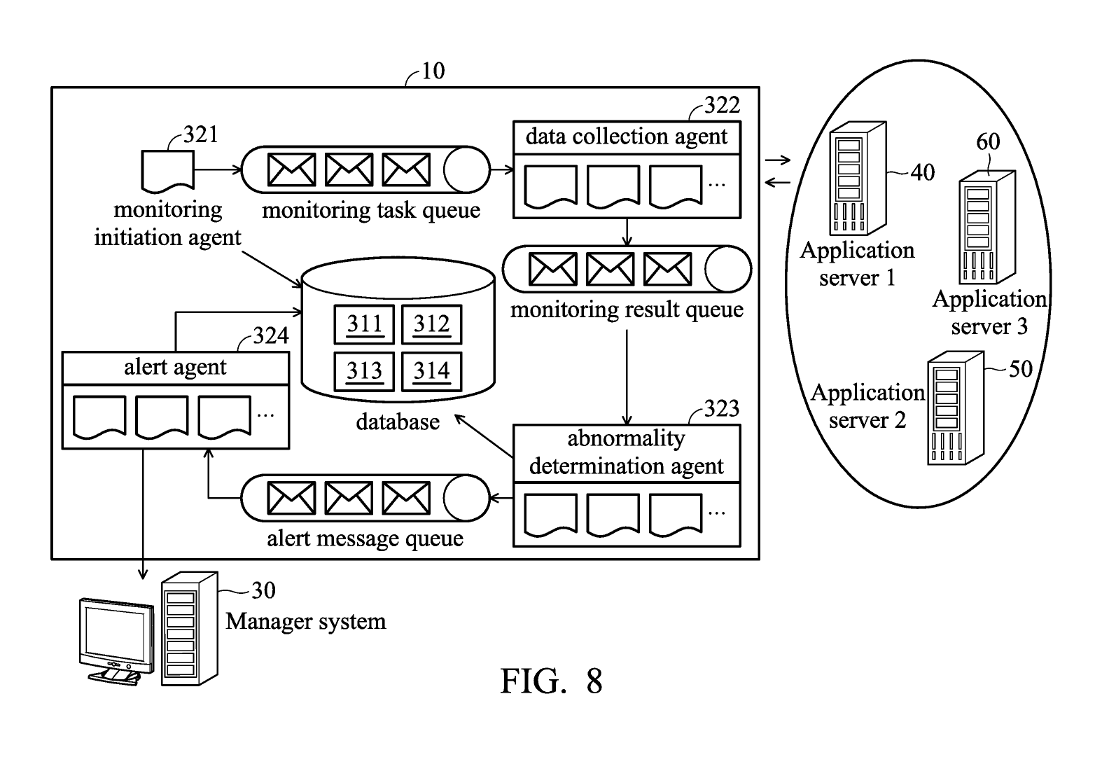

FIG. 8 is a block diagram illustrating the monitoring operation of the application servers according to the embodiment of FIG. 3. As shown in FIG. 8, the monitoring initiation agent 321 periodically checks the database for the monitoring configurations of the application servers 40˜60 and the configured monitoring items, and generates a monitoring task according to the result of the periodical check and stores the monitoring task into the monitoring task queue.

Subsequently, the data collection agent 322 monitors the application servers 40˜60 according to the monitoring task retrieved from the monitoring task queue and obtains the monitoring data, wherein the monitoring data is included in a monitoring result and stored into the monitoring result queue.

Next, the abnormality determination agent 323 retrieves the monitoring result from the monitoring result queue, and retrieves the abnormality definition from the database. Subsequently, the abnormality determination agent 323 determines whether the monitoring data in the monitoring result meets the abnormality definition, and generates an alert message for the abnormal monitoring data and stores the alert message into the alert message queue.

After that, the alert agent 324 retrieves the alert message from the alert message queue, and retrieves the alert rule from the database. Subsequently, the alert agent 324 determines whether or not to send the alert message to the manager system 30.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

Note that use of ordinal terms such as “first”, “second”, “third”, etc., in the claims to modify a claim element does not by itself connote any priority, precedence, or order of one claim element over another or the temporal order in which acts of the method are performed, but are used merely as labels to distinguish one claim element having a certain name from another element having the same name (except for use of ordinal terms), to distinguish the claim elements.

What is claimed is:

1. A monitoring system, comprising:
a communication device, configured to provide a network connection to the Internet and one or more application servers on the Internet;
a storage device, configured to store computer-executable instructions or program code; and
a controller, configured to load and execute the computer-executable instructions or program code to monitor the application servers, wherein the monitoring of the application servers comprises:
initiating a first process to serve as a first task agent for determining whether there is a monitoring item among the application servers and generating a monitoring task when there is a monitoring item among the application servers;
initiating a second process to serve as a second task agent for obtaining monitoring data by monitoring the monitoring item according to the monitoring task;
initiating a third process to serve as a third task agent for determining whether the monitoring data meets an abnormality definition associated with the monitoring task and generating an alert message when the monitoring data meets the abnormality definition; and
initiating a fourth process to serve as a fourth task agent for determining, according to an alert rule, whether or not to send the alert message to a manager of the application server with which the monitoring item is associated.

2. The monitoring system as claimed in claim 1, wherein the storage device is further configured to store a database maintaining monitoring configurations associated with the application servers, and the first task agent further determines whether a current time falls within an activation period in the monitoring configurations, and the monitoring task is generated when the current time falls within the activation period.

3. The monitoring system as claimed in claim 1, wherein the first task agent further determines whether the monitoring item is in a retry state, and determines whether a current time has reached a retry time of the monitoring item, and the monitoring task is generated when the current time has reached the retry time.

4. The monitoring system as claimed in claim 1, wherein the monitoring item is a service run on one of the application servers, and the monitoring task comprises at least one of a monitoring target, a monitoring type, a monitoring rule, the abnormality definition, and the alert rule.

5. The monitoring system as claimed in claim 1, wherein the third task agent further stores the monitoring data in a database maintained in the storage device and sets the monitoring item to be in a normal state when the monitoring data does not meet the abnormality definition, determines whether the monitoring item is in a retry state when the monitoring data meets the abnormality definition, stores the monitoring data in the database and sets the monitoring item to be in the retry state when the monitoring item is not in the retry state, determines whether the monitoring item has been retried a predetermined number of times when the monitoring item is in the retry state, stores the monitoring data in the database when the monitoring item has not been retried the predetermined number of times, and the alert message is generated when the monitoring item has been retried the predetermined number of times.

6. The monitoring system as claimed in claim 1, wherein the alert rule indicates one of the following:
sending the alert message for each occurrence of an abnormality;
sending the alert message only once for all occurrences of the same abnormality;
sending the alert message only once in a predetermined period of time for all occurrences of the same abnormality; and
sending the alert message for a predetermined number of occurrences of the same abnormality.

7. The monitoring system as claimed in claim 1, wherein the first task agent further stores the monitoring task into a first queue for the second task agent to retrieve, the second task agent further stores the monitoring data into a second queue for the third task agent to retrieve, and the third task agent further stores the alert message into a third queue for the fourth task agent to retrieve.

8. The monitoring system as claimed in claim 7, wherein the monitoring of the application servers further comprises:
initiating another process to duplicate the second task agent when a number of monitoring tasks in the first queue exceeds a first threshold;
initiating another process to duplicate the third task agent when an amount of monitoring data in the second queue exceeds a second threshold; and
initiating another process to duplicate the fourth task agent when a number of alert messages in the third queue exceeds a third threshold.

9. The monitoring system as claimed in claim 8, wherein the monitoring of the application servers further comprises:
removing the duplicate of the second task agent when the number of monitoring tasks in the first queue is less than a fourth threshold;
removing the duplicate of the third task agent when the amount of monitoring data in the second queue is less than a fifth threshold; and
removing the duplicate of the fourth task agent when the number of alert messages in the third queue is less than a sixth threshold.

10. The monitoring system as claimed in claim 7, wherein:
when an error occurs during the second task agent's monitoring of the monitoring item, the second task agent determines whether it has retried the monitoring of the monitoring item a first predetermined number of times, and stores the monitoring task back into the first queue when it has not retried the monitoring of the monitoring item the first predetermined number of times;
when an error occurs during the third task agent's determination of whether the monitoring data meets the abnormality definition, the third task agent determines whether it has retried the determination of whether the monitoring data meets the abnormality definition a second predetermined number of times, and stores the monitoring data back into the second queue when it has not retried the determination of whether the monitoring data meets the abnormality definition the second predetermined number of times; and
when an error occurs during the fourth task agent's determining whether to send the alert message, the fourth task agent determines whether it has retried the determination of whether to send the alert message a third predetermined number of times, and stores the alert message back into the third queue when it has not retried the determination of whether to send the alert message the third predetermined number of times.
